(19) United States
(12) Patent Application Publication
(10) Pub. No.: US 2023/0375692 A1
(43) Pub. Date: Nov. 23, 2023

(54) DEVICE FOR AND METHOD OF PREDICTING A TRAJECTORY OF A VEHICLE

(71) Applicant: Dr. Ing. h.c. F. Porsche Aktiengesellschaft, Stuttgart (DE)

(72) Inventors: Tudor Ziman, Cluj Napoca (RO); Gabriel Berecz, Cluj Napoca (RO); Rares Barbantan, Cluj Napoca (RO); Nicolae Petridean, Cluj Napoca (RO)

(21) Appl. No.: 18/031,295

(22) PCT Filed: Oct. 13, 2020
(86) PCT No.: PCT/EP2020/025453

§ 371 Date: Apr. 11, 2023

(51) Int. Cl. G01S 13/58; B60W 40/10; G01S 13/86; G01S 13/931; B60W 40/02

(52) U.S. Cl. CPC G01S 13/58; B60W 40/10; G01S 13/867; G01S 13/931; B60W 40/02; G01S 2013/9323; B60W 2420/52; B60W 2420/42

(57) ABSTRACT

An apparatus and method are provided for predicting a trajectory (106) of a vehicle (102). The method includes capturing information about the vehicle (102) and/or information about a road structure surrounding the vehicle (102). The method proceeds by selecting a mode of evaluating a future trajectory of the vehicle (102) depending on the information about the vehicle (102) and/or the information about the road structure (104) surrounding the vehicle (102), and determining the future trajectory of the vehicle according a model. The mode defines an influence of the information about the vehicle (102) and/or the information about the road structure (104) surrounding the vehicle (102) in the model.

### BACKGROUND

### Field of the Invention

The invention concerns a device for and a method of predicting a trajectory of a vehicle, in particular a vehicle that moves next to an observing vehicle.

### Object of the Invention

It is desirable to predict trajectories of vehicles surrounding a vehicle for the next seconds from sensor information.

### SUMMARY OF THE INVENTION

A method of predicting a trajectory of a vehicle comprises capturing information about the vehicle and/or information about a road structure surrounding the vehicle, selecting a mode of evaluating a future trajectory of the vehicle depending on the information about the vehicle and/or the information about the road structure surrounding the vehicle, and determining the future trajectory of the vehicle according a model. The mode defines an influence of the information about the vehicle and/or the information about the road structure surrounding the vehicle in the model. Thus, the predicted trajectories of vehicles surrounding a vehicle for the next seconds is determined reliably from sensor information. Information from each sensor is evaluated independently without data fusion or artificial intelligence.

In some embodiments, the information about the vehicle is radar information, camera information or lidar information. The information about the road structure may be camera information.

In one aspect, the mode selected depending on a threshold. The threshold defines a length of a time span for that data points that have been captured before selecting the mode or the threshold defines an amount of data points that have been captured before selecting the mode. The threshold parameter can take a value from 0.1 to 10 seconds. An amount of data points corresponding to this time span can be defined as threshold as well. For example, the value may be considered to be 5 seconds. This value is variable and may be varied.

The data points that have been captured before selecting the mode within the time span or the amount of data points that have been captured before selecting the mode are in one aspect input to the model when the length of the time or the amount of data points exceeds the threshold.

The model may comprise a kinematic model for the vehicle and a road structure model for the road surrounding the vehicle. In this aspect, an influence of the kinematic model and the road structure model may be determined depending on the mode.

The mode may be selected from at least a first mode, a second mode and a third mode. In the first mode, the influence of the kinematic model is higher than the influence of the road structure model. In the second mode, the influence of the kinematic model and the influence of the road structure model are balanced. In the third mode, the influence of the kinematic model is less than the influence of the road structure model. This method determines safety zones and uses specific algorithms in different regions where they are the most beneficial. For example, in an imminent safety zone the kinematic model has higher influence. In a critical safety zone, there is a balanced influence of the kinematic model and the road structure. In a standard safety zone, the road structure has higher influence.

The device for predicting a trajectory of a vehicle comprises at least one sensor and a controller. The at least one sensor is configured for capturing information about the vehicle and/or information about a road structure surrounding the vehicle. The controller is configured for selecting a mode of evaluating a future trajectory of the vehicle depending on the information about the vehicle and/or the information about the road structure surrounding the vehicle, and for determining the future trajectory of the vehicle according a model. The mode defines an influence of the information about the vehicle and/or the information about the road structure surrounding the vehicle in the model.

The at least one sensor may be at least one camera, at least one lidar sensor or at least one radar sensor. A vehicle may comprise the device.

Further advantageous embodiments are derivable from the following description and the drawings.

### BRIEF DESCRIPTION OF THE DRAWINGS

FIG. 1 schematically depicts a road with vehicles.

FIG. 2 schematically depicts aspects of a device for predicting a trajectory.

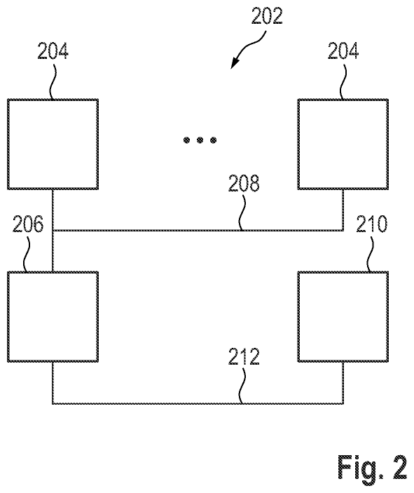

FIG. 3 schematically depicts steps in a method for predicting a trajectory.

FIG. 4 schematically depicts a mapping of safety zones to modes of the method.

### DETAILED DESCRIPTION

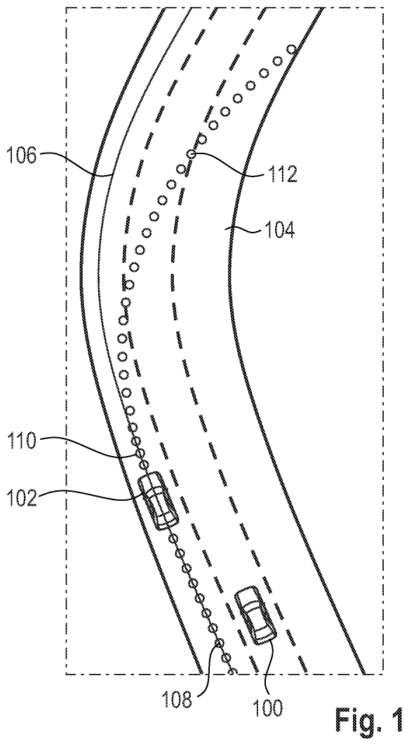

FIG. 1 depicts a part of a road on which a first vehicle 100 and a second vehicle 102 move on a road structure 104. A future trajectory 106 for the second vehicle 102 is depicted in FIG. 1 as solid line. A time span of a historic trajectory 108 of the second vehicle 102 is depicted as sequence of dots. The dots in the example relate to an amount of data points.

The first vehicle 100 comprises a device 202 for predicting the future trajectory 106 of the second vehicle 102. The first vehicle 100 comprises least one sensor 204 configured for capturing information about the second vehicle 102 and/or information about the road structure 104 surrounding the second vehicle 102.

The at least one sensor 204 in the example is at least one camera, at least one lidar sensor or at least one radar sensor. The device 202 comprises a controller 206 configured for selecting a mode of evaluating the future trajectory 106 of the second vehicle 102 depending on the information about the second vehicle and/or the information about the road structure 104 surrounding the second vehicle 102 and for determining the future trajectory 106 of the second vehicle 102 according a model. A first data link 208 connects the at least one sensor 204 and the controller 206. The device 202 may comprise or may be connectable to at least on actuator 210 via a second data link 212 that connects the at least one actuator 210 and the controller 206. The actuator 210 may output information about the future trajectory 106 or influence an operation of the first vehicle 100 depending on the future trajectory 106.

The mode defines an influence of the information about the second vehicle 102 and/or the information about the road structure 104 surrounding the second vehicle 102 in the model. The model is explained below in detail.

The model comprises a kinematic model for the second vehicle 104 and a road structure model for the road surrounding the second vehicle 104. The kinematic model may be a Constant Yaw Rate and Acceleration, CYRA, model determining a CYRA prediction. In FIG. 1, a first prediction 110 by the kinematic model is depicted for a time span of 0 to 0.4 seconds. A second prediction 112 by the kinematic model is depicted for a time span of 0.4 to 5 seconds.

The model in the example has the following defined safety zones in the exemplary 5 seconds of the future trajectory 106:
0-2 seconds (0-72.2 meters at 130 km/h):
IMMINENT safety zone

High accuracy required as any wrong decision will have an immediate effect.

The kinematic model is suitable for this zone, as they will reliably estimate where the second vehicle 102 is going.
2-3 seconds (72.2-108.3 meters at 130 km/h):
CRITICAL safety zone

Any collision detected in this zone, or later, can be safely avoided. An error of the kinematic model starts to increase significantly in this zone.
3-5 seconds (108.3-180.5 meters at 130 km/h): STANDARD safety zone

It is hard to predict the position of the car accurately in this zone.

The kinematic model has high errors and is not reliable. The road structure model approximates the longitudinal position of the second vehicle 102 better than the kinematic model.

For the kinematic model, the Constant Yaw Rate and Acceleration, CYRA, model may be used.

A state space of the model can be defined as:

\vec{x}(t)=(xyθvaw)^{T}
with
x=Longitudinal position, y=Lateral position
θ=Yaw angle, w=Yaw rate
v=Velocity,

$$\vec{x} ( t + T ) = \vec{x} ( t ) + ( \begin{matrix}\begin{matrix}\begin{matrix}\begin{matrix}\begin{matrix}Δ x ( T ) \\ Δ y ( T )\end{matrix} \\ ω T\end{matrix} \\ a T\end{matrix} \\ 0\end{matrix} \\ 0\end{matrix} )$$

$$Δ x ( T ) = \frac{1}{{ω}^{2}} [ ( v ( t ) ω + a ω T ) sin ( θ ( t ) + ω T ) + a cos ( θ ( t ) + ω T ) - v ( t ) ω sin θ ( t ) - a cos θ ( t ) ]$$

$$Δ y ( T ) = \frac{1}{{ω}^{2}} [ ( - v ( t ) ω - a ω T ) cos ( θ ( t ) + ω T ) + a sin ( θ ( t ) + ω T ) + v ( t ) ω cos θ ( t ) - a sin θ ( t ) ]$$

The controller 206 is adapted in one aspect to estimate a road path independently, depending on sensor data points from each sensor separately. This is referred to as road path smoothing.

The controller 206 may take into consideration the path of each detected second vehicle 104 around the first vehicle 100 and may compute a hybrid computation between the CYRA model and this estimation to better fit the predicted path of the detected second vehicles 104.

This trajectory prediction is done independently for each second vehicle 104. There is no data fusion required.

In one mode, historic data points of the position of the second vehicle 102 over the last 1 second are available to the controller 206. The at least one sensor 204 is adapted to capture the current position, acceleration, velocity and yaw for the second vehicle 104. In this mode, a list of data points for the historic trajectory 108 of the position of the second vehicle 104 over the last 1 second is gathered. The current position, acceleration, velocity and yaw is gathered for the second vehicle 104 and is input to the CYRA model. The CYRA prediction is determined over the next 0.4 seconds. This results in a list of data points for the predicted future trajectory 106. Using the data points for the historic trajectory 108 and the predicted data points from CYRA model, a quadratic curve is fit in the example using a least squares method. This will be described below in further detail.

When no history or less than 1 second history is available, the current position, acceleration, velocity and yaw is gathered for the second vehicle 104. The current position, acceleration, velocity and yaw that has been gathered for the second vehicle 104 is input to the CYRA model.

Data analysis showed that the first second of a trajectory history is sufficient to reliably estimate the future trajectory. Data analysis showed that in the first 0.4 seconds the CYRA prediction has a very small error, e.g. few centimeters.

To fit the quadratic curve using the least squares method, the coefficients (a, b, c) of a quadratic polynomial Q(x)=ax2+bx+c are determined that best fits the given list of N data points in the sense of least squares.

The problem implies minimizing the error function:

$$Err ( Q ( {x}_{i} ) ) = {\sum }_{i = 1}^{N} {( Q ( {x}_{i} ) - {y}_{i} )}^{2}$$

Which requires:

$$\frac{\partial Err}{\partial a} = \frac{\partial Err}{\partial b} = \frac{\partial Err}{\partial c} = 0$$

The equation of the partial derivative with respect to a is:

$$\frac{\partial Err}{\partial a} = {\sum }_{i = 1}^{N} 2 ( {ax}_{i}^{2} + {bx}_{i} + c - {y}_{i} ) {x}_{i}^{2} = 2 [ a {\sum }_{i = 1}^{N} {x}_{i}^{4} + b {\sum }_{i = 1}^{N} {x}_{i}^{3} + c {\sum }_{i = 1}^{N} {x}_{i}^{2} - {\sum }_{i = 1}^{N} {x}_{i}^{2} {y}_{i} ] = 0$$

$$a {\sum }_{i = 1}^{N} {x}_{i}^{4} + b {\sum }_{i = 1}^{N} {x}_{i}^{3} + c {\sum }_{i = 1}^{N} {x}_{i}^{2} = {\sum }_{i = 1}^{N} {x}_{i}^{2} {y}_{i}$$

The equation of the partial derivative with respect to b is:

$$\frac{\partial Err}{\partial b} = {\sum }_{i = 1}^{N} 2 ( {ax}_{i}^{2} + {bx}_{i} + c - {y}_{i} ) {x}_{i} = 2 [ a {\sum }_{i = 1}^{N} {x}_{i}^{3} + b {\sum }_{i = 1}^{N} {x}_{i}^{2} + c {\sum }_{i = 1}^{N} {x}_{i} - {\sum }_{i = 1}^{N} {x}_{i} {y}_{i} ] = 0$$

$$a {\sum }_{i = 1}^{N} {x}_{i}^{3} + b {\sum }_{i = 1}^{N} {x}_{i}^{2} + c {\sum }_{i = 1}^{N} {x}_{i} = {\sum }_{i = 1}^{N} {x}_{i} {y}_{i}$$

The equation of the partial derivative with respect to c is:

$$\frac{\partial Err}{\partial c} = {\sum }_{i = 1}^{N} 2 ( {ax}_{i}^{2} + {bx}_{i} + c - {y}_{i} ) {x}_{i}^{2} = 2 [ a {\sum }_{i = 1}^{N} {x}_{i}^{2} + b {\sum }_{i = 1}^{N} {x}_{i} + cN - {\sum }_{i = 1}^{N} {y}_{i} ] = 0$$

$$a {\sum }_{i = 1}^{N} {x}_{i}^{2} + b {\sum }_{i = 1}^{N} {x}_{i} + cN = {\sum }_{i = 1}^{N} {y}_{i}$$

The resulting system with 3 equations and 3 unknown terms (a, b, c) is

$$( \begin{matrix}N & {\sum }_{i = 1}^{N} {x}_{i} & {\sum }_{i = 1}^{N} {x}_{i}^{2} \\ {\sum }_{i = 1}^{N} {x}_{i} & {\sum }_{i = 1}^{N} {x}_{i}^{2} & {\sum }_{i = 1}^{N} {x}_{i}^{3} \\ {\sum }_{i = 1}^{N} {x}_{i}^{2} & {\sum }_{i = 1}^{N} {x}_{i}^{3} & {\sum }_{i = 1}^{N} {x}_{i}^{4}\end{matrix} ) ( \begin{matrix}\begin{matrix}\begin{matrix}\begin{matrix}\begin{matrix}\begin{matrix}c \\ \end{matrix} \\ \end{matrix} \\ b\end{matrix} \\ \end{matrix} \\ \end{matrix} \\ a\end{matrix} ) = ( \begin{matrix}\begin{matrix}{\sum }_{i = 1}^{N} {y}_{t} \\ {\sum }_{i = 1}^{N} {x}_{i} {y}_{i}\end{matrix} \\ {\sum }_{i = 1}^{N} {x}_{i}^{2} {y}_{i}\end{matrix} )$$

This system is solved based on the list of data points to determine the coefficients (a, b, c) of the quadratic polynomial Q(x)=ax²+bx+c that best fits the data points.

For the road structure model, a clothoid may be used as a curve whose curvature C, changes linearly with its curve length L

The clothoid may be parametrically defined:

$$x = \frac{1}{a} {{\int }_{0}}^{L} cos {t}^{2} dt$$

$$y = \frac{1}{a} {{\int }_{0}}^{L} sin {t}^{2} dt$$

$$with Curvature = \frac{YawRate}{Velocity} ↔ C = \frac{ω}{v}$$

The clothoid may be normalized, to scale the values down with a factor of a:

$$a = \frac{1}{\sqrt{2 RL}} , {L}^{′} = a L$$

Using parametric equations, N data points a, b, c(xᵢ′, yᵢ′) are computable. Then the values may be scaled back up with a factor of

$$\frac{1}{a} .$$

The final trajectory may be computed taking into consideration the kinematic model, e.g. the CYRA model, and the road structure model.

In one example, the controller 206 is adapted to merge the kinematic model and the road structure model depending on the safe zone.

In the IMMINENT safety zone, the kinematic model has a high influence,

In the CRITICAL safety zone, a balanced influence of the kinematic model and the road structure model are used.

In the STANDARD safety zone, the road structure model has a high influence.

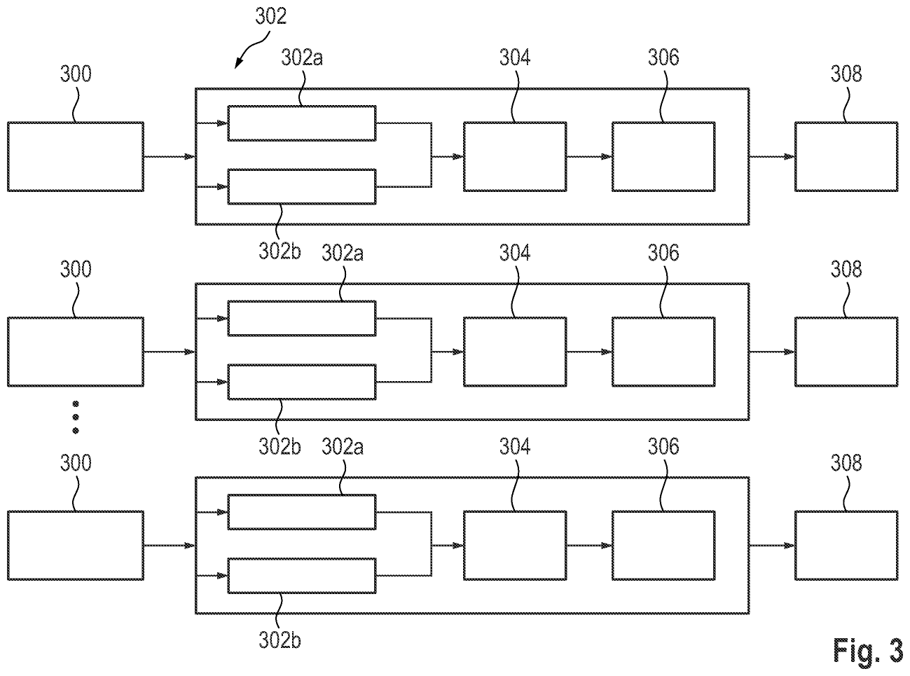

A method of predicting the future trajectory 106 of the second vehicle 102 is described with reference to FIG. 3. The method operates without sensor data fusion. In FIG. 3, a plurality of parallel computations for different sensors is depicted. Individual outputs are determined as well. In the example, different outputs for the second vehicle 102 is described. The output may be trajectories for a plurality of different vehicles surrounding the first vehicle 100.

In a step 300 information about the second vehicle 102 is captured.

In step 300 information about the road structure 104 surrounding the second vehicle 102 is captured.

The information about the second vehicle 102 is radar information, camera information or lidar information. The information about the road structure is camera information.

In a step 302, the output of the individual model parts is determined. The model in the example comprises the kinematic model 302a for the second vehicle 102 and the road structure model 302b for the road surrounding the second vehicle 102.

In a step 304, the mode of evaluating the future trajectory 106 of the second vehicle 102 is selected depending on the information about the second vehicle 102 and/or the information about the road structure surrounding the second vehicle 102.

The mode in this example defines an influence of the information about the second vehicle 102 and/or the information about the road structure surrounding the second vehicle 102 in the model.

The mode is selected from at least a first mode, a second mode and a third mode. In the example, the first mode is for the imminent safety zone, the second mode is for the critical safety zone and third mode is for the standard safety zone. In the first mode the influence of the kinematic model is higher than the influence of the road structure model influence, wherein in the second mode the influence of the kinematic model is and the influence of the road structure model are balanced, and in the third mode the influence of the kinematic model is less than the influence of the road structure model influence.

The mode is selected in the example depending on a threshold. The threshold defines a length of a time span for that data points have been captured before selecting the mode or that the threshold defines an amount of data points that have been captured before selecting the mode.

In a step 306, the future trajectory 106 of the second vehicle 102 is determined according the model.

The data points that have been captured before selecting the mode within the time span or the amount of data points that have been captured before selecting the mode are input in step 306 to the model when the length of the time span or the amount of data points exceeds the threshold.

An influence of the kinematic model and the road structure model is determined in this example depending on the mode.

The method may comprise a step 308 of actuating the at least one actuator 210 according to the future trajectory 106.

The method may comprise actuating the actuator 210 to output information about the future trajectory 106 or influence an operation of the first vehicle 100 depending on the future trajectory 106.

This history based kinematic trajectory prediction uses safety zones in order to decide how to evaluate the future trajectory 106. These safety zones can vary in time span and can be adjusted initially, dependent on the desired application.

The accuracy on vehicle trajectory prediction is improved in view of other existing solutions. An advantage is that it is flexible on the application and takes into consideration the efficient mix between the models. The safety of the first vehicle 100 based on surrounding traffic is highly optimized by these safety zones. The solution determines safety zones and uses specific algorithms presented above in the region where they are the most beneficial. The approach is a hybrid one that has an overall better performance and a scalable approach over each defined safety zone.

Instead of computing the road path from every the perspective of every vehicle, a driving tube may be created based on collective information provided by a specific sensor.

Each sensor in this example captures objects and has its specific information. For example, a camera sensor can capture the lines, but a radar sensor not.

Based on the objects position and the specific information, the method may comprise computing the road path with a higher accuracy. The predictions of the trajectory will be determined independently by each sensor.

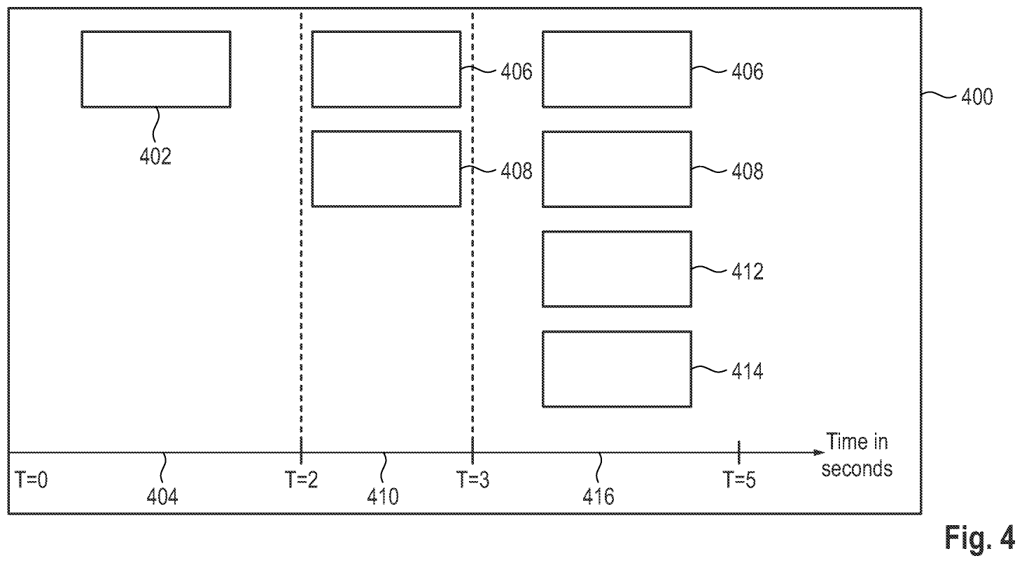

FIG. 4 schematically depicts an exemplary mapping 400 of the safety zones to the modes. In the example, the kinematic model 402, in particular CYRA, is used in the imminent safety zone 404 that starts in the exemplary 5 seconds of the future trajectory 106 at time T=0 and ends at T=2. This corresponds to the first mode. In the example, the road path smoothing 406 and a maneuver detection 408 are used in the critical safety zone 410 that starts at T=2 and ends at T=3.

This corresponds to the second mode. In the example, road path smoothing 406, the maneuver detection 408, a cut in detection 412 and the driving tube 414 are used in the standard safety zone 416 that starts at T=3 and ends at T=5. This corresponds to the third mode.

1. A method for predicting a trajectory (106) of a vehicle (102), comprising: capturing (300) information about the vehicle (102) and/or information about a road structure surrounding the vehicle (102), selecting (304) a mode of evaluating a trajectory of the vehicle (102) depending on the information about the vehicle (102) and/or the information about the road structure (104) surrounding the vehicle (102), and determining (306) the trajectory of the vehicle according a model, wherein the mode defines an influence of the information about the vehicle (102) and/or the information about the road structure (104) surrounding the vehicle (102) in the model.

2. The method of claim 1, wherein the information about the vehicle (102) is radar information, camera information or lidar information.

3. The method of claim 1, wherein the information about the road structure (104) is camera information.

4. The method of claim 1, wherein the mode is selected (304) depending on a threshold, wherein the threshold defines a length of a time span for data points that have been captured before selecting the mode or the threshold defines an amount of data points that have been captured before selecting the mode.

5. The method of claim 4, wherein the data points that have been captured before selecting the mode within the time span or the amount of data points that have been captured before selecting the mode are input (306) to the model when the length of the time or the amount of data points exceeds the threshold.

6. The method of claim 1, wherein the model comprises a kinematic model for the vehicle (102) and a road structure model for the road surrounding (104) the vehicle (102).

7. The method of claim 6, wherein an influence of the kinematic model and the road structure model is determined (306) depending on the mode.

8. The method of claim 7, wherein the mode is selected (304) from at least a first mode, a second mode and a third mode, wherein in the first mode the influence of the kinematic model is higher than the influence of the road structure model, wherein in the second mode the influence of the kinematic model and the influence of the road structure model are balanced, and wherein in the third mode the influence of the kinematic model is less than the influence of the road structure model.

9. A device (204) for predicting a trajectory of a vehicle (102), comprising at least one sensor (206) configured for capturing information about the vehicle and/or information about a road structure (104) surrounding the vehicle (102), a controller (206) configured for selecting a mode of evaluating a trajectory (106) of the vehicle (102) depending on the information about the vehicle and/or the information about the road structure (104) surrounding the vehicle, (102) and for determining the trajectory (106) of the vehicle (102) according a model, wherein the mode defines an influence of the information about the vehicle (102) and/or the information about the road structure (104) surrounding the vehicle (102) in the model.

10. The device (204) of claim 9, wherein the at least one sensor (206) is at least one camera, at least one lidar sensor or at least one radar sensor.

11. A vehicle (100), comprising the device (204) of claim 9.
